(19) United States
(12) Patent Application Publication
(10) Pub. No.: US 2026/0062223 A1
(43) Pub. Date: Mar. 5, 2026

(54) AUTOMATIC SELF ALIGNING AND SELF SUSTAINING BELT TRACKING SYSTEM FOR BELTED CONVEYORS

(71) Applicant: Dematic Corp., Grand Rapids, MI (US)

(72) Inventor: Shreedhar M. Hebbur, Byron Center, MI (US)

(21) Appl. No.: 19/108,249

(22) PCT Filed: Sep. 7, 2023
(86) PCT No.: PCT/IB2023/058883

§ 371 Date: Mar. 3, 2025

Related U.S. Application Data
(60) Provisional application No. 63/404,316, filed on Sep. 7, 2022.

(51) Int. Cl. B65G 15/64; B65G 23/04

(52) U.S. Cl. CPC B65G 15/64; B65G 23/04; B65G 2203/0283

(57) ABSTRACT

A conveyor surface adjustment system (100) includes first and second belt tracking actuators (106a, 106b) positionable at opposite first and second sides (102a, 102b) of a conveyor belt (102). An adjustable roller (120) in movable contact with the belt (102) has a fixed end (120a) and an adjustable end (120b) coupled to an adjustment gear (118). When the belt (102) is improperly positioned or aligned towards the first (106a) or second belt tracking actuator (106b), the belt (102) physically contacts or engages the first (106a) or second belt tracking actuator (106b). The engaged belt tracking actuator (106a, 106b) causes the gear (118) to rotate in either a first direction or a second direction to move the adjustable end (120b) of the adjustable roller (120) to adjust the tension of the belt (102). This tension change causes the belt (102) to track towards a corrected position or alignment.

### CROSS REFERENCE TO RELATED APPLICATION

The present invention claims priority of U.S. provisional application Ser. No. 63/404,316, filed on Sep. 7, 2022, which is hereby incorporated herein by reference in its entirety.

### BACKGROUND AND FIELD OF THE INVENTION

The present invention relates generally to a conveyor system, and more particularly to an alignment system for a conveyor belt.

A conveyor system typically includes a driven conveyor surface, such as a belt, for moving an object. The belt is driven in a conveyor direction by a roller, in which the belt is aligned or oriented in a certain way with the roller. During operation, the belt may become misaligned with the roller, and/or may become skewed or driven at an undesired angle relative to the conveyor direction. While misaligned and/or skewed in this way, the conveyor system may operate at a lower efficiency, while the belt or other components may also experience more rapid degradation, thus potentially resulting in a reduction of overall operational efficiency or other issues. A user, such as a technician or other trained personnel, may manually readjust the alignment and/or orientation of the belt or conveyor surface while the conveyor system is shut down to return the conveyor system to a state of desired operation.

### SUMMARY OF THE INVENTION

The conveyor surface adjustment system of the present invention is operable to self-align and/or automatically correct the position and/or orientation of a conveyor surface or belt while the belt is still moving or being driven. Various embodiments are described in the accompanying claims. In general, a pair of belt tracking actuators or belt trackers may be positioned on opposing sides of the belt and remain unaffected by the belt while the belt is properly aligned and/or oriented. One of the belt trackers may become engaged by the belt if the belt becomes misaligned or improperly skewed in one direction. Depending on which belt tracker becomes engaged or affected by the belt, a series of gears and/or other mechanical components are actuated to rotate an adjustable gear or roller adjuster depending on the misalignment to thereby automatically adjust or correct the tracking of the belt. In a particular configuration, an adjustable end of an adjustable roller is coupled to the roller adjuster and is moveable in response to movement of the roller adjuster. As such, the belt is movable in response to a movement of the adjustable roller such that tension applied to the belt is varied by the adjustable roller. As the roller adjuster is actuated, the adjustable end of the adjustable roller is pivoted or moved relative to a fixed or stationary end of the adjustable roller to adjust the tension of the belt at or proximate the adjustable roller, such that the belt has a higher tension at one side proximate one end of the adjustable roller relative to the opposite side of the belt. The belt is urged to move or track in the direction of the side of the belt with lower tension, thereby causing a change or adjustment to the position/orientation of the belt within the conveyor system. Depending which belt tracker is engaged by the belt, the adjustable end of the adjustable roller may be moved and/or pivoted in different directions to provide tension to the belt in a manner causing the belt to track away from the engaged belt tracker, thus automatically improving the belt alignment or positioning.

According to one form of the present invention, a conveyor surface adjustment system includes an adjustable roller configured to be in moveable contact with a conveyor belt, and includes a roller adjuster that is configured to selectively adjust the position of the adjustable roller, and a belt tracking actuator. The belt tracking actuator is configured to be actuated by the conveyor belt if the conveyor belt becomes misaligned and is thus in a misaligned condition, with the belt tracking actuator in turn actuating the roller adjuster to adjust the position of the adjustable roller to thereby automatically adjust the tracking of the conveyor belt into an aligned condition.

In one aspect, the belt tracking actuator includes a rotational member that is configured to be engaged by the conveyor belt when the conveyor belt is in a misaligned condition with the conveyor belt imparting rotational motion to the belt tracking actuator. The belt tracking actuator in turn imparts rotational motion to the roller adjuster to adjust the position of the adjustable roller. Optionally, the belt tracking actuator includes a pulley. Additionally, the axis of rotation of the rotational member of the belt tracking actuator is configured to rotate either parallel to or perpendicular to the axis of rotation of the adjustable roller.

In another aspect, the belt tracking actuator includes a belt position sensor configured to detect a misalignment condition of the conveyor belt. The roller adjuster includes an electric motor configured to be actuated when the sensor detects a misalignment condition of the conveyor belt, in which the electric motor is coupled to the adjustable roller for adjusting the position of the adjustable roller. Optionally, the sensor is a proximity sensor or a laser sensor.

In yet another aspect, the belt tracking actuator is a first belt tracking actuator and the system further includes a second belt tracking actuator, in which the first and second belt tracking actuators are located on opposed sides of the conveyor belt. The first belt tracking actuator is configured to be actuated by the conveyor belt when in a first misaligned condition tracking to one side, while the second belt tracking actuator configured to be actuated by the conveyor belt when in a second misaligned condition tracking to the opposite side. Optionally, the second belt tracking actuator includes either a rotational member or a belt position sensor.

In still another aspect, the adjustable roller includes a fixed end and a movable end, and wherein the roller adjuster is joined to the moveable end.

In a further aspect, the roller adjuster includes a gear assembly in which an end of the adjustable roller is coupled to the gear assembly, and where rotation of the gear assembly adjusts the position of the adjustable roller. Optionally, the gear assembly includes a ring gear, and the end of the adjustable roller is coupled to the ring gear with an axis of rotation of the adjustable roller being offset from a rotational axis of the ring gear. The gear assembly may include a spiral threaded shaft that engages with the ring gear, in which rotation of the spiral threaded shaft rotates the ring gear. Optionally, the spiral threaded shaft is selectively actuated for rotation by the tracking actuator.

According to another form of the present invention, a conveyor belt adjustment system includes an adjustable roller configured to be in moveable contact with a conveyor belt, a roller adjuster configured to selectively adjust the position of the adjustable roller, and a first belt tracking actuator and a second belt tracking actuator disposed at opposing sides of the conveyor belt. The first belt tracking actuator is configured to be actuated by the conveyor belt when in a first misaligned condition tracking to one side. The first belt tracking actuator in turn actuates the roller adjuster in a first direction to adjust the tracking of the conveyor belt into an aligned condition. The second belt tracking actuator is configured to be actuated by the conveyor belt when in a second misaligned condition tracking to the opposite side. The second belt tracking actuator in turn actuates the roller adjuster in a second direction to adjust the tracking of the conveyor belt into the aligned condition.

In one aspect, the first belt tracking actuator is rotatable independent of the second belt tracking actuator when the conveyor belt actuates the first belt tracking actuator, and the second belt tracking actuator is rotatable independent of the first belt tracking actuator when the conveyor belt actuates the second belt tracking actuator.

In another aspect, the first and second belt tracking actuators include horizontal pulleys disposed coaxially with and at opposite ends of a fixed roller.

In yet another aspect, the adjustable roller includes a fixed end located opposite a movable end, in which the movable end is coupled to the roller adjuster such that a longitudinal axis of the adjustable roller is offset from a geometric center of the roller adjuster. Optionally, the first and second belt tracking actuators are configured to rotate the roller adjuster when the conveyor belt actuates either of the first or second belt tracking actuators, the rotation of the roller adjuster moving the movable end along an arcuate path to pivot the adjustable roller. The movable end may be movable between a position above the fixed end to cause the tension of the conveyor belt to be greater proximate the fixed end relative to the tension of the conveyor belt proximate the movable end, and a position below the fixed end to cause the tension of the conveyor belt to be greater proximate the movable end relative to the tension of the conveyor belt proximate the fixed end.

In still another aspect, the roller adjuster includes a worm gear. Optionally, a transmission shaft coupled to the first and second belt tracking actuators and to the worm gear, rotates in the first direction when the conveyor belt actuates the first belt tracking actuator, and rotates in the second direction when the conveyor belt actuates the second belt tracking actuator. A worm may be configured to be rotated by the transmission shaft to thereby rotate the worm gear.

In a further aspect, the first and second belt tracking actuators include first and second vertical pulleys configured to rotate independently and oppositely relative to one another upon being actuated by the conveyor belt. Optionally, a transmission band is configured to transfer rotational motion from the first and second vertical pulleys to the roller adjuster.

In yet a further aspect, an electric motor is configured to rotate the roller adjuster, in which the first and second belt tracking actuators include first and second photo-optic sensing devices. The conveyor belt actuates the first photo-optic sensing device upon being detected by the first photo-optic sensing device to cause the electric motor to rotate the roller adjuster in the first direction, while the conveyor belt actuates the second photo-optic sensing device upon being detected by the second photo-optic sensing device to cause the electric motor to rotate the roller adjuster in the second direction.

In still a further aspect, an electric motor is configured to rotate the roller adjuster, in which the first and second belt tracking actuators include first and second laser sensors configured to output first and second lasers, respectively. The conveyor belt actuates the first laser sensor when the conveyor belt obstructs the first laser, thereby causing the electric motor to rotate the roller adjuster in the first direction, while the conveyor belt actuates the second laser sensor when the conveyor belt obstructs the second laser, thereby causing the electric motor to rotate the roller adjuster in the second direction.

According to yet another form of the present invention, a conveyor belt self-alignment system for maintaining an alignment of a conveyor belt of a conveyor system includes a first belt tracking actuator and a second belt tracking actuator disposed at opposing sides of the conveyor belt, an adjustable roller having a fixed end located opposite a movable end, and configured to be in moveable contact with the conveyor belt, and a roller adjustment gear configured to selectively adjust the position of the adjustable roller. The movable end of the adjustable roller is coupled to the roller adjustment gear such that a longitudinal axis of the adjustable roller is not aligned with a geometric center of the roller adjustment gear. The first belt tracking actuator is configured to be actuated by the conveyor belt when in a first misaligned condition tracking to one side with the first belt tracking actuator in turn rotating the roller adjustment gear in a first direction. Rotation of the adjustment gear in the first direction moves the movable end of the adjustable roller to adjust the tension across the conveyor belt at the adjustable roller to urge the conveyor belt away from the first belt tracking actuator into an aligned condition. The second belt tracking actuator is configured to be actuated by the conveyor belt when in a second misaligned condition tracking to the opposite side with the second belt tracking actuator in turn rotating the roller adjustment gear in a second direction opposite the first direction. Rotation of the roller adjustment gear in the second direction moves the movable end of the adjustable roller to adjust the tension across the conveyor belt at the adjustable roller to urge the conveyor belt away from the second belt tracking actuator into an aligned condition.

In one aspect, the first belt tracking actuator rotates in the second direction independent of the second belt tracking actuator when the conveyor belt actuates the first belt tracking actuator, while the second belt tracking actuator rotates in the second direction independent of the first belt tracking actuator when the conveyor belt actuates the second belt tracking actuator.

In another aspect, the first and second belt tracking actuators include horizontal pulleys disposed coaxially with and at opposite ends of a fixed roller. Optionally, a transmission shaft is coupled to the first and second belt tracking actuators and is rotatable in the first direction when the first belt tracking actuator is actuated by the conveyor belt, and is rotatable in the second direction when the second belt tracking actuator is actuated by the conveyor belt. A worm configured to rotate upon rotation of the transmission shaft is configured to engage the roller adjustment gear which may be a worm gear, such that rotation of the worm causes the worm gear to rotate.

In yet another aspect, a distal gear assembly is coupled between the first belt tracking actuator and the transmission shaft, in which the distal gear assembly is configured to transfer a rotational motion of the first belt tracking actuator in the second direction into a rotational motion of the transmission shaft in the first direction.

According to still another form of the present invention, a conveyor belt self-alignment system for maintaining an alignment of a conveyor belt of a conveyor system includes a first belt tracking actuator at a first side of the conveyor belt, and a second belt tracking actuator at a second side of the conveyor belt opposite the first side of the conveyor belt. An adjustable roller includes a fixed end located opposite a movable end, and is configured to be in movable contact with the conveyor belt in which the conveyor belt passes underneath the adjustable roller. A roller adjuster is configured to selectively adjust the position of the adjustable roller, in which the movable end of the adjustable roller coupled to the roller adjuster such that a longitudinal axis of the adjustable roller is not aligned with a geometric center of the roller adjuster. The first belt tracking actuator is configured to be actuated by the conveyor belt if the conveyor belt is in a first misaligned condition tracking to one side with the first belt tracking actuator in turn rotating the roller adjuster in a first direction to move the movable end upward along an arcuate path at the roller adjuster. This movement of the movable end causes a tension across the conveyor belt be greater proximate the fixed end relative to the movable end to adjust the tracking of the conveyor belt into an aligned condition. The second belt tracking actuator is configured to be actuated by the conveyor belt if the conveyor belt is in a second misaligned condition tracking to the opposite side with the second belt tracking actuator in turn rotating the roller adjuster in a second direction to move the movable end downward along the arcuate path at the roller adjuster. This movement of the movable end causes a tension across the conveyor belt be greater proximate the movable end relative to the fixed end to adjust the tracking of the conveyor belt into an aligned condition.

In one aspect, a pair of fixed rollers are located above the adjustable roller, in which one of the pair of fixed rollers is located forward of the adjustable roller, while one of the pair of fixed rollers is located rearward of the adjustable roller. The fixed rollers are configured to be in movable contact with the conveyor belt in which the conveyor belt passes over the pair of fixed rollers.

According to another form of the present invention, a conveyor belt adjustment system includes a belt position sensor located proximate a conveyor belt of a conveyor system. An adjustable roller is configured to be in moveable contact with the conveyor belt. A roller adjuster is configured to selectively adjust the position of the adjustable roller. An electric motor is in electronic communication with the belt position sensor and coupled to the roller adjuster. The electric motor is configured to urge the roller adjuster when the conveyor belt is detected by the belt position sensor, where the belt is detected by the belt position sensor when the belt is in a misaligned condition. The movement of the roller adjuster pivots the adjustable roller to adjust a tension of the conveyor belt at the adjustable roller to thereby adjust the tracking of the conveyor belt into an aligned condition.

In one aspect, the belt position sensor is a first belt position sensor located proximate a first side of the conveyor belt, while a second belt position sensor is located proximate a second side of the conveyor belt opposite the first side. The electric motor is configured to urge the roller adjuster in a first direction when the first belt position sensor detects the conveyor belt in a first misaligned condition tracking to one side, and is also configured to urge the roller adjuster in a second direction opposite the first direction when the second belt position sensor detects the conveyor belt in a second misaligned condition tracking to an opposite side. The movement of the roller adjuster in the first direction pivots the adjustable roller to adjust a tension of the conveyor belt at the adjustable roller to adjust the tracking of the conveyor belt into the aligned condition, while the movement of the roller adjuster in the second direction pivots the adjustable roller to adjust a tension of the conveyor belt at the adjustable roller to adjust the tracking of the conveyor belt into the aligned condition.

In another aspect, the adjustable roller includes a fixed end located opposite a movable end, in which the movable end coupled to the roller adjuster such that a longitudinal axis of the adjustable roller is offset from a geometric center of the roller adjuster.

In yet another aspect, the electric motor is configured to rotate the roller adjuster when the conveyor belt is detected by either of the first or second belt position sensors in either of the first or second misaligned conditions, in which the rotation of the roller adjuster moves the movable end along an arcuate path to pivot the adjustable roller. Optionally, the movable end is movable between a position above the fixed end to cause the tension of the conveyor belt to be greater proximate the fixed end relative to the tension of the conveyor belt proximate the movable end, and a position below the fixed end to cause the tension of the conveyor belt to be greater proximate the movable end relative to the tension of the conveyor belt proximate the fixed end.

In still another aspect, the first and second belt position sensors include first and second photo-optic sensing devices configured to optically detect the conveyor belt.

In a further aspect, the first and second belt position sensors include first and second laser sensors configured to output first and second lasers, respectively. The first laser sensor detects the conveyor belt in the first misaligned condition when the first laser is obstructed by the conveyor belt, while the second laser sensor detects the conveyor belt in the second misaligned condition when the second laser is obstructed by the conveyor belt.

Thus, the conveyor surface adjustment system of the present invention may be incorporated into existing conveyor systems or designed as part of a new conveyor system for automatically correcting the position and orientation of a conveyor surface, such as a belt. A pair of belt trackers are positioned on each side of the belt, and when engaged and/or physically contacted by the belt (when the belt is improperly positioned or misaligned) cause the actuation and/or rotation of a roller adjuster. An adjustable roller provides tension to the belt, and has a fixed end located opposite a movable end that is coupled with the roller adjuster. The movable end of the adjustable roller is moved in response to actuation of the roller adjuster and thereby creates or adjusts the tension gradient across the belt proximate the adjustable roller. Depending on which belt tracker is engaged by the belt, the movable end is moved a particular direction to adjust the tension gradient of the belt in such a way as to cause the belt to track towards an improved or corrected position and/or orientation, thus reducing downtime associated with manually correcting the belt position, reducing belt wear due to improper belt alignment, and improving the overall operational efficiency of a conveyor system.

These and other objects, advantages, purposes and features of the present invention will become apparent upon review of the following specification in conjunction with the drawings.

### BRIEF DESCRIPTION OF THE DRAWINGS

FIG. 1 is a perspective view of a conveyor system having a belt alignment system in accordance with an aspect of the present invention, shown with a belt of the conveyor system mistracking in a leftward direction relative to the direction of travel of the belt;

FIG. 1A is a top perspective view of the conveyor system of FIG. 1;

FIG. 1B is a bottom perspective view of the conveyor system of FIG. 1;

FIG. 1C is a front perspective view of the conveyor system of FIG. 1;

FIG. 1D is a rear perspective view of the conveyor system of FIG. 1;

FIG. 2A is a right side elevation view of an alignment gear box of the conveyor system of FIG. 1 disclosing an adjustable roller mount and shown with the belt mistracking in the leftward direction of FIG. 1;

FIG. 2B is a left side elevation view of a fixed mount of the alignment system of FIG. 1, shown with the belt mistracking in the leftward direction of FIG. 1;

FIG. 3A is right side elevation view of the alignment gear box of FIG. 2A, in which the adjustable roller mount is rotated counterclockwise to increase tension at the side of the adjustable roller mount and thereby move the tracking of the belt toward the fixed mount side to correct leftward mistracking of the belt;

FIG. 3B is a left side elevation view of the fixed mount of FIG. 2B, shown with the leftward mistracking of the belt being corrected;

FIG. 4 is a perspective view of the conveyor system and belt alignment system of FIG. 1, shown with the belt mistracking in a rightward direction relative to the direction of travel of the belt;

FIG. 5A is a right side elevation view of the alignment gear box of FIG. 2A, shown with the belt mistracking in the rightward direction;

FIG. 5B is a left side elevation view of the fixed mount of FIG. 2B, shown with the belt mistracking in the rightward direction;

FIG. 6A is a right side elevation view of the alignment gear box of FIG. 2A, in which the adjustable mount is rotated clockwise to increase tension at the side of the fixed mount and thereby move the tracking of the belt toward the adjustable roller mount side to correct rightward mistracking of the belt;

FIG. 6B is a left side elevation view of the fixed mount of FIG. 2B, shown with the rightward mistracking of the belt being corrected;

FIG. 7 is a perspective view of a conveyor system having an alternative embodiment of a belt alignment system in accordance with another aspect of the present invention, in which the belt alignment system includes vertically-oriented belt tracking actuators, and shown with a belt of the conveyor system mistracking in a leftward direction relative to the direction of travel of the belt;

FIG. 8 is a perspective view of the conveyor system and alternative belt alignment system of FIG. 7, shown with the belt mistracking in a rightward direction; and

FIG. 9 is a perspective view of a conveyor system having yet another alternative embodiment of a belt alignment system in accordance with another aspect of the present invention, the belt alignment system including a pair of belt tracking actuators comprising sensors for sensing a position of a belt of the conveyor system.

### DETAILED DESCRIPTION OF THE PREFERRED EMBODIMENTS

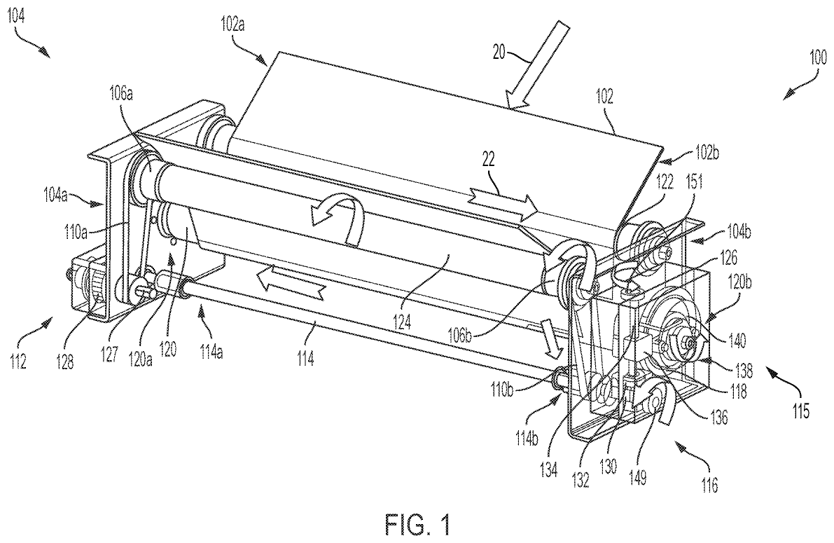

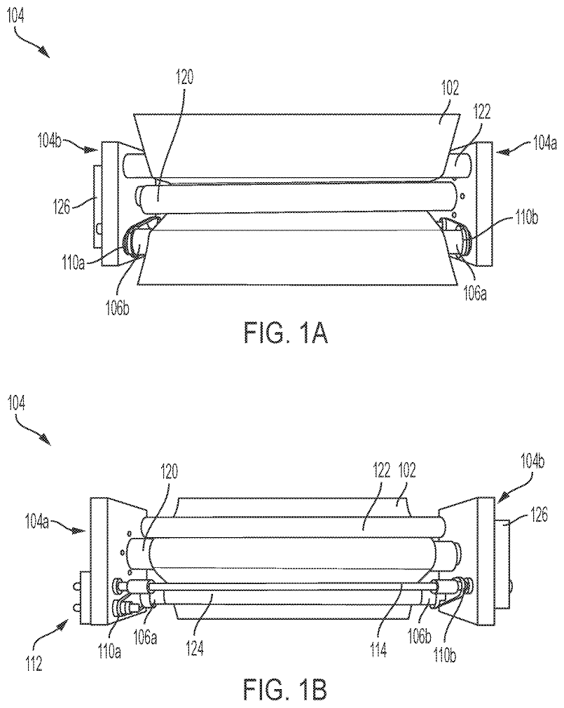

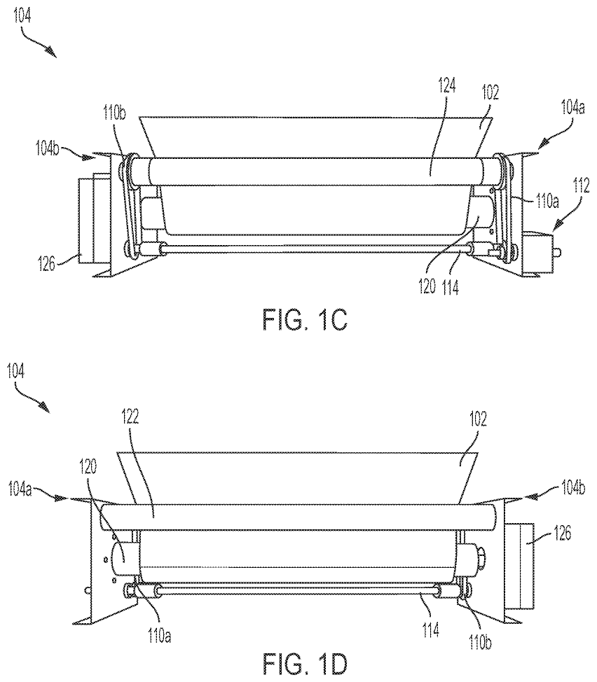

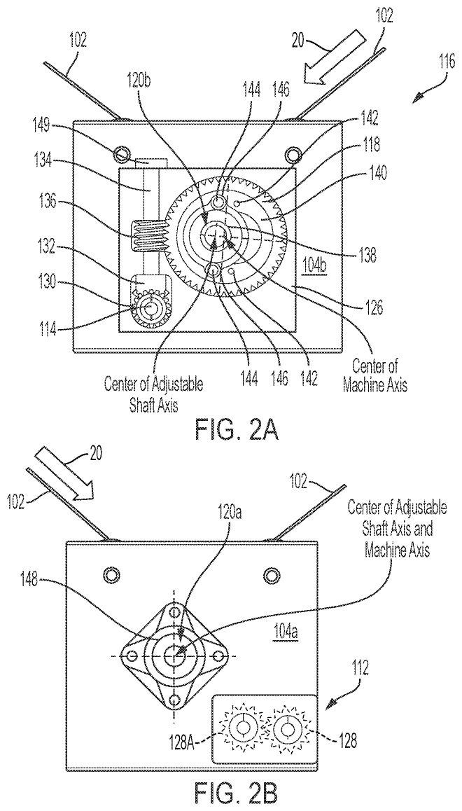

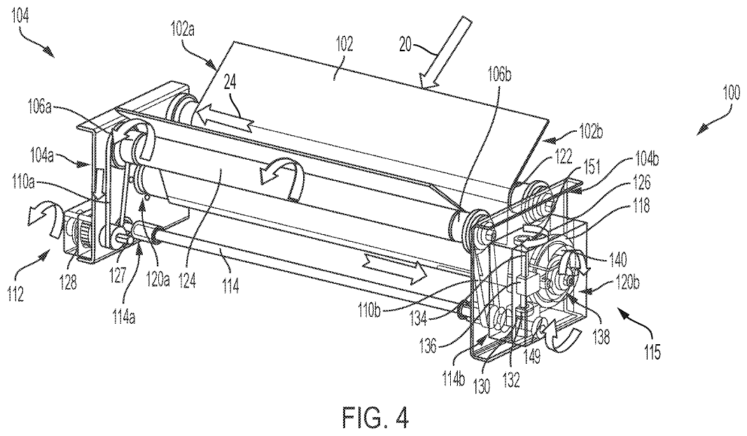

The present invention will now be described with reference to the accompanying figures, wherein the numbered elements in the following written description correspond to like-numbered elements in the figures. With initial reference to FIGS. 1-6B, a conveyor surface or belt adjustment system or self-alignment system in the form of belt adjustment system 100 is adapted to automatically improve and/or correct the tracking, alignment, position and/or orientation of a belt 102 of a conveyor system 104. One or the other of a pair of conveyor or belt tracking actuators in the form of a right or first belt tracking actuator 106a and a left or second belt tracking actuator 106b are actuated when belt 102 becomes misaligned by the actuators 106a, 106b being engaged by belt 102. Actuators 106a, 106b are coupled to an adjustable roller mount 115 disposed on a left side that selectively adjusts a roller 120 over which belt 102 traverses to adjust the tension on the belt 102 depending on whether the belt 102 is mistracking to the left 22 (FIG. 1) or to the right 24 (FIG. 4) relative to the direction of travel 20 of belt 102. As discussed in detail below, when the belt is mistracking to the left (FIG. 1) the adjustable roller mount 115 is caused to rotate in one direction to impart additional tension to belt 102 at the end 120b of roller 120 to cause belt 102 to automatically move toward the right side 104a of conveyor 104 to correct the tracking of belt 102. Conversely, when the belt is mistracking to the right (FIG. 2) the adjustable roller mount 115 is caused to rotate in the opposite direction whereby tension on belt 102 at the end 120a of roller 120 causes belt 102 to automatically move toward the left side 104b of conveyor 104 to correct the tracking of belt 102.

In the embodiment of FIGS. 1-6B, first and second belt tracking actuators 106a, 106b are coupled to opposing sides of a fixed forward or first roller 124 in which the fixed roller 124 has a fixed rotation axis. The actuators 106a and 106b are each configured to individually rotate independent of one another if belt 102 makes contact with one or the other of the belt tracking actuators 106a, 106b. With reference to FIG. 4, when belt 102 mistracks to the right 24 it engages belt tracking actuator 106a, rotation of which causes the rotation of a right band 110a (e.g. belt or chain) to actuate a distal or right side gear assembly 112, which in turn rotates a transmission shaft 114. Transmission shaft 114 transfers rotational motion from a right side 104a of conveyor system 104 to left side gear assembly 116 on a left side 104b of conveyor system 104. With reference to FIG. 1, when belt 102 mistracks to the left 22 it engages belt tracking actuator 106b, rotation of which causes the rotation of a left band 110b (e.g. belt or chain) to transfer motion to gear assembly 116. As will be discussed later, the gear assembly 116 includes and causes rotation of a worm gear 118. An adjustable member in the form of an adjustable or tiltable roller or tension roller 120 supports belt 102 and includes a fixed end 120a and an adjustable or moveable end 120b. The movable or adjustable end 120b of roller 120 is fixed to the worm gear 118 in an offset manner such that the geometric center of worm gear 118 is offset from the rotation axis of roller 120. Worm gear 118 is automatically rotated either clockwise or counterclockwise depending on whether belt 102 contacts and rotates belt tracking actuator 106a or 106b. Rotation of worm gear 118 pivots adjustable roller 120 in a particular direction to adjust and/or affect the tension of belt 102 near, at, or across adjustable roller 120. That is, rotation of worm gear 118 causes adjustable end 120b to move along an arcuate path at worm gear 118 to thereby pivot adjustable roller 120. This change in the tension gradient across belt 102 causes belt 102 to move, realign, reposition, and/or re-orient towards an improved or corrected alignment, position, and/or tracking orientation to thus improve the overall operational efficiency of conveyor system 104 and/or reduce the wear and tear on belt 102.

With reference to the illustrated embodiment of FIGS. 1-1D, a conveyor surface in the form of belt 102 is fed, driven, moved, and/or conveyed through a series of conveyor members of a conveyor system 104 in direction 20. The conveyor members include an upstream/rearward roller 122, a downstream/forward roller 124, and an adjustable roller 120. Both rearward roller 122 and forward roller 124 are fixed rollers, or rollers only capable of rotating about their longitudinal rotation axis, while adjustable roller 120 is both capable of rotating about its longitudinal axis and having its longitudinal axis moved or adjusted vertically and/or laterally. Belt 102 is arranged to move or travel sequentially over the upper side of rearward roller 122, beneath the lower side of adjustable roller 120, and over the upper side of forward roller 124. As such, the tension of belt 102 may be adjusted or changed depending on the position of adjustable roller 120. Furthermore, the tension gradient across belt 102 at and between a first/right side 102a and a second/left side 102b can be adjusted and/or changed based on the positon of adjustable roller 120. For example, the tension of left side 102b of belt 102 can be increased by lowering adjustable end 120b of adjustable roller 120, while the tension of left side 102b of belt 102 can be reduced by raising adjustable end 120b of adjustable roller 120. As will be explained in detail later, the tension gradient or lack thereof across belt 102 at or near adjustable roller 120 may be used to change at least the position and/or alignment of belt 102 within conveyor system 104.

Right belt tracking actuator 106a and left belt tracking actuator 106b are mounted to opposing ends of fixed forward roller 124 with right belt tracking actuator 106a disposed at or near right side 102a of belt 102, and left belt tracking actuator 106b disposed at or near left side 102b of belt 102. Belt tracking actuators 106a, 106b are provided in the form of horizontal pulleys in the illustrative embodiment of FIGS. 1-1D and 4—in which a longitudinal axis of the horizontal pulleys is oriented in a substantially horizontal plane—and which may be rotated independent of one another and may also be rotated independent of forward roller 124. Belt tracking actuators 106a, 106b are substantially coaxial with the forward roller 124 and thus are rotatable about the same axis as roller 124. When properly aligned, belt 102 remains substantially centered and moves substantially perpendicular with respect to forward roller 124. Further, when properly aligned, belt 102 is able to move over forward roller 124 between belt tracking actuators 106a and 106b without impacting, engaging, or making physical contact with either belt tracking actuators 106a or 106b. When belt 102 becomes misaligned, skewed, or otherwise improperly positioned, a corresponding side of belt 102 may impact, engage, or make physical contact with a corresponding one of belt tracking actuators 106a or 106b. The movement of belt 102 over one of belt tracking actuators 106a, 106b causes the one of belt tracking actuators 106a, 106b to rotate in a forward direction or second direction.

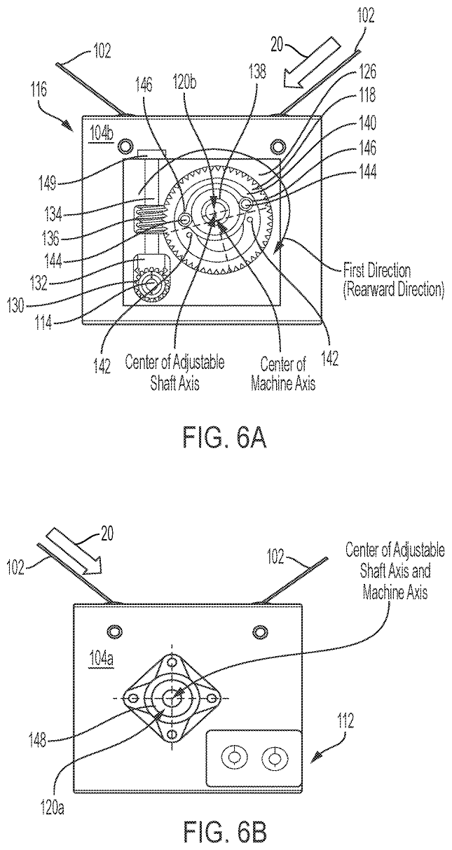

Belt tracking actuators 106a, 106b are operably coupled to proximal gear assembly 116 that is substantially contained within a gear box or proximal gear housing 126 at right side 104b of conveyor system 104. Movement of belt tracking actuators 106a, 106b is transferred to and actuates proximal gear assembly 116. Actuation of proximal gear assembly 116 changes the position of adjustable end 120b of adjustable roller 120. With reference to FIG. 4, rotation of right belt tracking actuator 106a in the forward direction (e.g. when belt 102 contacts belt tracking actuator 106a) causes right band 110a to move and urge a distal shaft 127 to rotate in a forward direction that is the same direction as the rotation of belt tracking actuator 106a. The forward direction is counterclockwise when viewed from the left side of FIGS. 1 and 4. Distal gear assembly 112 includes a pair of gears in the form of a first spur gear 128 (FIGS. 1, 2B and 4) that is engaged with a second spur gear 128a (FIG. 2B). First spur gear 128 is mounted to distal shaft 127, and rotates in the forward direction upon rotation of distal shaft 127 in the forward direction. Forward rotation of first spur gear 128 causes the second spur gear 128a to rotate in a rearward direction (or clockwise when viewed from the left side of FIGS. 1 and 4). The second spur gear is mounted at or near a distal end portion 114a of transmission shaft 114, thus causing transmission shaft 114 to similarly rotate in the rearward direction upon rotation of second spur gear. A proximal end portion 114b of transmission shaft is located inside proximal gear housing 126. A first bevel gear 130 is fixed to the proximal end 114b of transmission shaft 114. A second bevel gear 132—oriented substantially perpendicular to first bevel gear 130 and engaged with first bevel gear 130—is mounted to a threaded shaft, which in the illustrated embodiment is shown as a vertical or upright shaft 134. The rotation of first bevel gear 130 in the rearward direction (due to the rotation of transmission shaft 114 in the rearward direction) causes clockwise rotation of second bevel gear 132, upright shaft 134, and a worm 136 mounted to upright shaft 134 when viewed from above with respect to FIG. 4 (clockwise rotation depicted with an arrow over upright shaft 134 in FIG. 4). Worm 136 is movably engaged to a roller adjuster or adjustment gear in the form of worm gear 118 such that rotation of worm 136 in the clockwise direction causes a rearward or clockwise rotation of worm gear 118 (see clockwise direction of rotation illustrated in FIG. 6A).

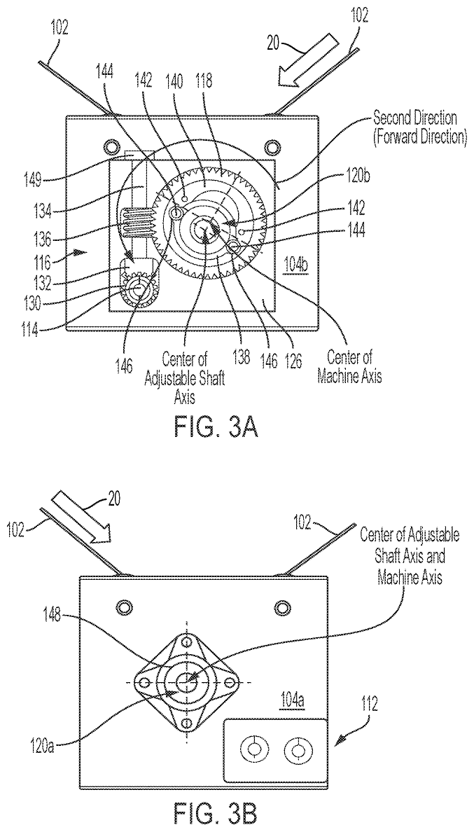

With reference to FIG. 1, rotation of left belt tracking actuator 106b in the forward direction (e.g. due to the belt 102 making contact with left belt tracking actuator 106b) causes left band 110b to move and thereby rotate transmission shaft 114 in the forward direction, thus also rotating first bevel gear 130 in the forward direction. Rotation of first bevel gear 130 in the forward direction causes counterclockwise rotation of second bevel gear 132, upright shaft 134, and worm 136 when viewed from above with respect to FIG. 1 (counterclockwise rotation depicted with an arrow over upright shaft 134 in FIG. 1). Rotation of worm 136 in the counterclockwise direction causes a forward or counterclockwise rotation of worm gear 118 (see counterclockwise direction of rotation illustrated in FIG. 3A).

As previously noted, adjustable end 120b of adjustable roller 120 is mounted to worm gear 118 at a position that is offset from a geometric center or machine axis of worm gear 118 (FIGS. 2A, 3A, 5A, and 6A). With reference to FIGS. 2A, 3A, 5A, and 6A, the offset is defined between the “center of machine axis” (i.e. the geometric center of the worm gear 118) and the “center of adjustable shaft axis” (i.e. the geometric and longitudinal center of adjustable roller 120). That is, the longitudinal axis of adjustable roller 120 and the machine axis of worm gear 118 cannot be shared, and/or simultaneously parallel and aligned in the same spatial dimensions. Therefore, adjustable end 120b is moved vertically and/or laterally relative to the fixed machine axis of worm gear 118 as worm gear 118 rotates. In the illustrated embodiment, adjustable end 120b of adjustable roller 120 is mounted to worm gear 118 via a proximal bearing 138, such as in the form of a ball bearing (FIGS. 2A, 3A, 5A, and 6A). An inner ring of bearing 138 is coupled to adjustable end 120b of adjustable roller 120, and is rotatable relative to an outer ring of bearing 138. The outer ring of bearing 138 is coupled to an inner mount plate 140. Mount plate 140 is coupled to worm gear 118. Mount plate 140 includes a plurality of mounting holes 142 with internal threading adapted to receive and secure a threaded fastener, such as bolts 144. Bearing 138 has a pair of bolt flanges 146 through which bolts 144 may extend to mount bearing 138 to mount plate 140. The presence of alternative unused mounting holes 142 enables the adjustment of the mounting position of bearing 138 relative to worm gear 118, which may enable a user to adjust or modify the offset distance between adjustable roller 120 and worm gear 118.

Referring to the illustrative embodiment of FIGS. 2B, 3B, 5B, and 6B, fixed end 120a of adjustable roller 120 is mounted at the right side 104a of conveyor system 104 via a distal bearing 148 which may have characteristics similar to that of proximal bearing 138. Fixed end 120a is substantially incapable of moving and/or deviating from its mounted position, in which fixed end 120a is mounted such that the longitudinal axis of adjustable roller 120 (i.e. “center of adjustable shaft axis”) is substantially aligned or coaxial with the machine axis of worm gear 118 (“center of machine axis”; see FIGS. 2B, 3B, 5B, and 6B) regardless of the positon of adjustable end 120b of adjustable roller 120.

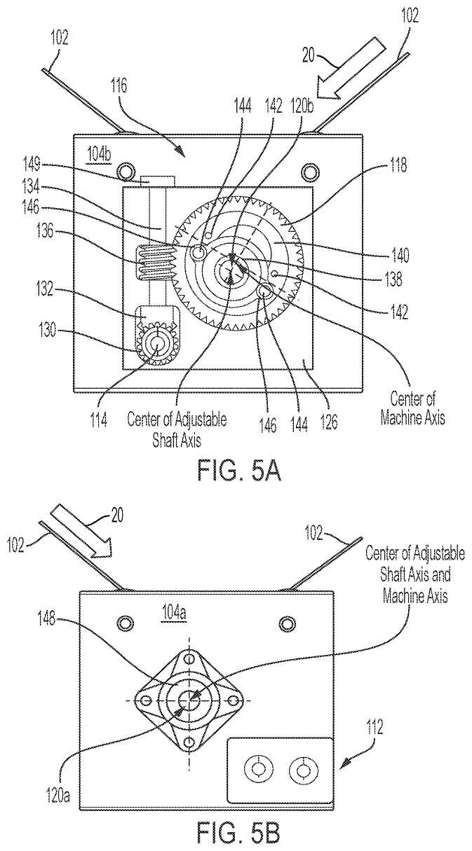

The following provides an example of operation of the system 100 when the belt 102 tracks toward and makes contact with the right belt tracking actuator 106a. The rearward rotation of worm gear 118 caused by belt 102 making contact with right belt tracking actuator 106a causes, at least in certain instances, upward movement of adjustable end 120b of adjustable roller 120 (see sequential movement of adjustable end 120b between FIGS. 5A and 6A). As noted above, the position of fixed end 120a of adjustable roller 120 does not change to a significant degree. As a result of the upward movement of adjustable end 120b, the orientation of adjustable roller 120 changes such that adjustable end 120b changes from a lower position in which the roller axis at end 120b is below the center axis of worm gear 118 as depicted in FIG. 5A, and lower than fixed end 120a, to a higher position in which the roller axis at end 120b is above the center axis of worm gear 118 as depicted in FIG. 6A, and above fixed end 120a. As such, the left side 102b of belt 102—which is proximate adjustable end 120b of adjustable roller 120—experiences a reduction in tension. Meanwhile, right side 102a of belt 102—which is proximate fixed end 120a of adjustable roller 120—experiences a substantially unchanged tension. In this configuration, the tension gradient between right side 102a and left side 102b of belt 102 is such that the tension is greater at the right side 102a than the left 102b. Accordingly, the lower tension of left side 102b of belt 102 relative to right side 102a causes belt 102 to migrate, track, realign, and/or otherwise move away from the right belt tracking actuator 106a and towards left belt tracking actuator 106b. Once belt 102 has moved a sufficient distance away from the right belt tracking actuator 106a—in which belt 102 may be once again properly positioned or oriented—belt 102 will no longer be in contact with right belt tracking actuator 106a, such that right belt tracking actuator 106a will no longer be rotating or thereby causing worm gear 118 to rotate/be rotated. Thus, the position of adjustable roller 120 will remain fixed, or at least no longer be actively influenced, until belt 102 makes physical contact with one of belt tracking actuators 106a, 106b.

The following provides an example of operation of the system 100 when the belt 102 tracks toward and makes contact with the left belt tracking actuator 106b. The forward rotation of worm gear 118 caused by belt 102 making contact with left belt tracking actuator 106b causes, at least in certain instances, downward movement of adjustable end 120b of adjustable roller 120 (see sequential movement of adjustable end 120b between FIGS. 2A and 3A). As a result of the downward movement of adjustable end 120b, the orientation of adjustable roller 120 changes such that adjustable end 120b changes from a higher position, in which the roller axis at end 120b is generally alongside of the center axis of worm gear 118 as depicted in FIG. 2A, to a lower position, in which the roller axis at end 120b is below the center axis of worm gear 118 as depicted in FIG. 3A. Thus, left side 102b of belt 102 is pulled further downward such that left side 102b experiences an increase in tension. Meanwhile, right side 120a of belt 102 experiences a substantially unchanged tension. In this configuration, the tension gradient between right side 102a and left side 102b of belt 102 is such that the tension is greater at the left side 102b than the right 102a. Accordingly, the increased tension of left side 102b of belt 102 relative to right side 102a causes belt 102 to migrate, track, realign, and/or otherwise move away from the left belt tracking actuator 106b and towards right belt tracking actuator 106a. As explained above with regard to right belt tracking actuator 106a, once belt 102 has moved a sufficient distance away from the left belt tracking actuator 106b, belt 102 will no longer be in contact with left belt tracking actuator 106b, such that left belt tracking actuator 106b will no longer be rotating or thereby causing worm gear 118 to rotate, thus at least temporarily fixing or no longer actively influencing the position of adjustable roller 120. Manual adjustments may also be made using belt adjustment system 100 via a pair of manual adjustment knobs 149 and 151 located at the end of transmission shaft 114 and at the top of upright shaft 134, respectively (FIGS. 1 and 4).

The rotational speed of worm gear 118, and thus the rate at which adjustable roller 120 is adjusted, will be dependent on at least the rotational speed and characteristics of worm 136. Among other characteristics, the diameter and number of teeth of both worm 136 and worm gear 118 can be adjusted relative to one another to change the rotational speed of worm 118. The characteristics of various other meshed gears such as first spur gear 128 and the second spur gear, and/or first and second bevel gears 132, may also be designed and/or adjusted to result in varying rotational speeds of these components, and components operably connected to these components. The amount of friction force imparted on the belt tracking actuator 106a or 106b by the belt may also impact the rotational speed of worm gear 118, and thus the rate at which adjustable roller 120 is adjusted. For example, during initial contact of the belt on belt tracking actuator 106a or 106b may only impart a small amount of friction that causes belt tracking actuator 106a or 106b to rotate a relatively low rate and thus the adjustable roller 120 would move at a relatively slow rate vertically and/or laterally; whereas upon heavy contact of the belt on belt tracking actuator 106a or 106b may impart a significantly higher amount of friction that causes belt tracking actuator 106a or 106b to rotate a relatively high rate and thus the adjustable roller 120 would move at a faster rate vertically and/or laterally.

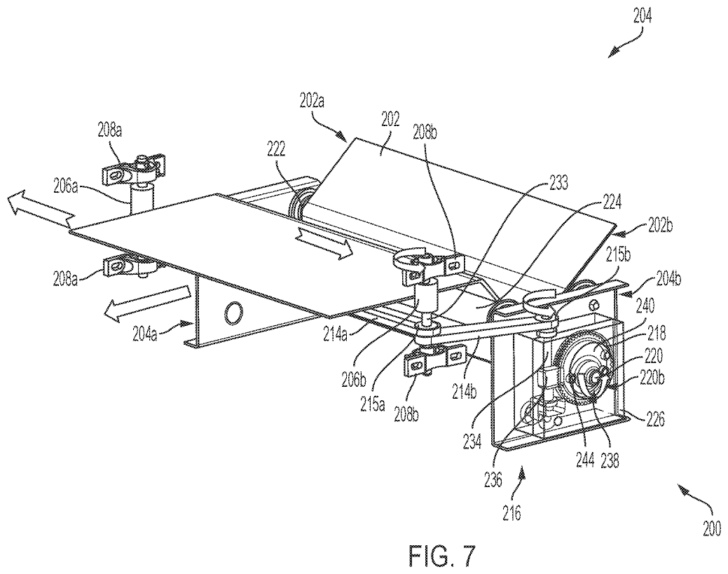

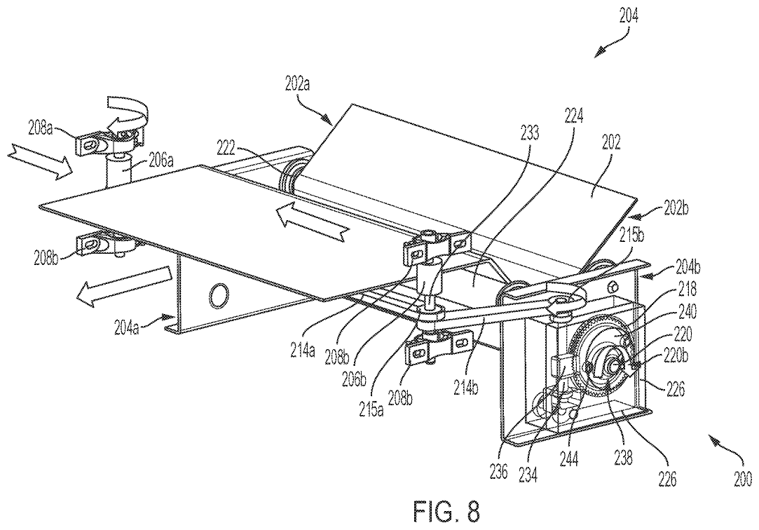

Referring now to the illustrated embodiment of FIGS. 7 and 8, another conveyor surface or belt adjustment system 200 is shown, and includes a right belt tracking actuator 206a and a left belt tracking actuator 206b, each in the form of vertical pulleys—in which a longitudinal axis of the vertical pulleys is disposed in a substantially vertical plane-disposed on opposing sides of a belt 202. The adjustment system 200 is configured similarly and functions in similar fashion to adjustment system 100 described above in reference to FIGS. 1-6B, and includes many identical or substantially similar components, with significant differences discussed hereinafter. Unlike belt tracking actuators 106a and 106b of adjustment system 100, belt tracking actuators 206a and 206b are not mounted to opposing ends of a forward roller 224. Instead, belt tracking actuators 206a and 206b include mounting brackets 208a, 208b that may be used to mount belt tracking actuators 206a, 206b to an external object, such as a wall or other stationary object adjacent the conveyor system 204. While belt 202 is properly aligned and oriented, belt 202 passes between belt tracking actuators 206a, 206b without making contact with either belt tracking actuator206a or 206b. When belt 202 becomes misaligned or miss-oriented, it will make contact with one of belt tracking actuators 206a, 206b, thus causing the at least one belt tracking actuator 206a, 206b to rotate as a result friction between the belt 202 and belt tracking actuator 206a or 206b.

The following provides an example of operation of the system 200 when the belt 202 tracks toward and makes contact with the right belt tracking actuator 206a. As depicted in FIG. 8, if a right side 202a of belt 202 makes contact with right belt tracking actuator 206a, then right belt tracking actuator 206a will begin to rotate clockwise when viewed from above. Rotation of right belt tracking actuator 206a causes a first transmission band 214a to move and/or rotate in the same direction as the belt tracking actuator 206a (clockwise when viewed from above). The first band 214a is engaged with a first transmission pulley 215a and is operable to rotate pulley 215a. A second transmission band 214b—also coupled to first transmission pulley 215a—begins to move and/or rotate in response to the rotation of first transmission pulley 215a. First transmission pulley 215a, as well as left belt tracking actuator 206b, are fixed to an upright shaft 233 that also supports left belt tracking actuator 206b. A second transmission pulley 215b is fixed to an upright worm shaft 234 and is configured to rotate along with first transmission pulley 215a and second transmission band 214b whenever the first transmission pulley 215a is rotating. In this example, the first transmission pulley 215a, upright shaft 233, second transmission band 214b, second transmission pulley 215b, and worm shaft 234 are all rotated clockwise (as viewed from above in FIG. 8) in response to the belt 202 contacting right belt tracking actuator 206a. A worm 236 is fixedly coupled to upright worm shaft 234 and rotates clockwise in response to the clockwise rotation of shaft 234. Worm 236 engages a worm gear 218 such that clockwise rotation of worm 236 causes rotation of worm gear 218 in the rearward direction, or first direction (i.e. clockwise when viewed from the left side in FIG. 8).

The following provides an example of operation of the system 200 when the belt 202 tracks toward and makes contact with the left belt tracking actuator 206b. As depicted in FIG. 7, if a left side 202b of belt 202 makes contact with left belt tracking actuator 206b, then left belt tracking actuator 206b will begin to rotate counterclockwise (as viewed from above in FIG. 7). Rotation of left belt tracking actuator 206b causes upright shaft 233 and thereby first transmission pulley 215a to rotate in the same direction (counterclockwise) and thus rotates second transmission band 214b in the counterclockwise direction. The second transmission band 214b drives rotation of second transmission pulley 215b and thereby rotate upright worm shaft 234 worm 236 counterclockwise. Worm 236 engages with worm gear 218 such that counterclockwise rotation of worm 236 causes rotation of worm gear 218 in the forward direction, or second direction (i.e. counterclockwise when viewed from the left side in FIG. 7).

System 200 includes an adjustable roller 220 that is substantially similar or identical in structure and function to adjustable roller 120 of illustrative embodiment of FIGS. 1-6A. Adjustable roller 220 includes a fixed end (not shown) mounted to a right side 204a of a conveyor system 204, and an adjustable end 220b coupled to worm gear 218 via a proximal bearing 238 at a location offset from a geometric center of worm gear 218. In like manner to belt adjustment system 100, belt adjustment system 200 also includes a proximal gear assembly 216 substantially contained within a proximal gear housing 226; a mount plate 240 having a plurality of mounting holes that may receive threaded bolts 244 extending through bolt flanges; and a distal bearing. Adjustable roller 220 is tilted and/or adjusted when the rotational motion of either belt tracking actuator 206a, 206b is transferred through proximal gear assembly 216 to rotate worm gear 218. The adjustments made to adjustable roller 220 in response to a specific belt tracking actuator 206a or 206b being contacted by belt 202 are substantially similar to those described above with respect to belt adjustment system 100.

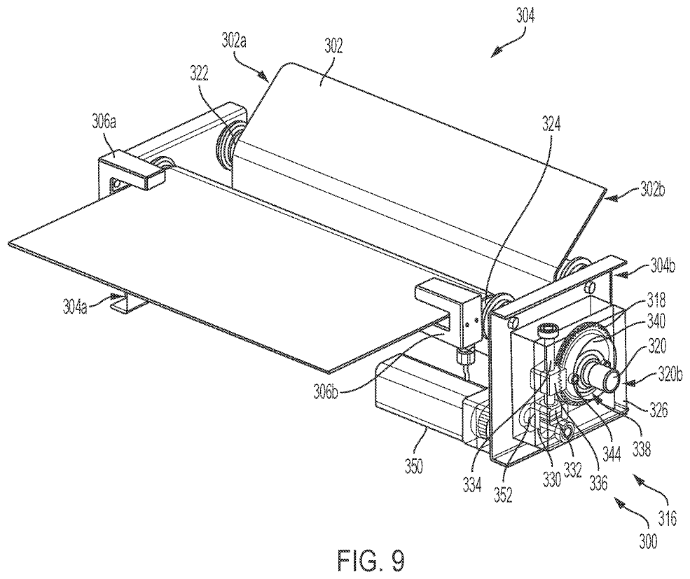

Referring now to the illustrated embodiment of FIG. 9, yet another conveyor surface or belt adjustment system 300 is shown. The adjustment system 300 includes many similarities in structure and function as compared to adjustment systems 100 and 200 described above in reference to FIGS. 1-6B and 7-8, respectively, with significant differences discussed hereinafter. Adjustment system 300 includes a right belt tracking actuator 306a and a left belt tracking actuator 306b in the form of sensing devices that are capable of detecting and/or sensing a position of a belt 302. Belt tracking actuators 306a, 306b are not mounted to opposing ends of a forward roller 324, and instead may be mounted directly to an external object, such as a wall or other stationary object in sufficient proximity to the conveyor system 304. In a substantially similar fashion to what has been previously with respect to belt adjustment system 100, a proximal gear assembly 316 that includes a first bevel gear 330, a second bevel gear 332, an upright shaft 334, a worm 336, and a worm gear 318—each arranged in a substantially identical fashion to like named components of previously described proximal gear assembly 116 described above with respect to adjustment system 100. Further similar to belt adjustment system 100, belt adjustment system 300 includes a proximal gear housing 326; a mount plate 340 having a plurality of mounting holes that may receive threaded bolts 344 extending through bolt flanges; a distal bearing; and a proximal bearing 338.

Proximal gear assembly 316 is operable to rotate worm gear 318 in a rearward or first direction when right belt tracking actuator 306a is activated or engaged, or a forward or second direction when left belt tracking actuator 306b is activated or engaged. The corresponding adjustments made to an adjustable roller 320 having a fixed end (not shown), and an adjustable end 320b mounted to worm gear 318 at a position offset from the geometric center of worm gear 318 are substantially similar to that described above with regards to either belt adjustment system 100 or belt adjustment system 200. However, when one of belt tracking actuators 306a, 306b is activated or engaged, a signal is sent to an electric motor 350 to energize electric motor 350 to rotate in either the rearward direction or the forward direction depending on which belt tracking actuator 306a, 306b was activated or engaged by belt 302. Motor 350 is operably coupled to proximal gear assembly 316. Specifically, first bevel gear 330 is coupled to a motor shaft 352 of motor 350 such that activation of motor 350 actuates proximal gear assembly 316.

As noted above, belt tracking actuators 306a, 306b are sensing devices that can detect and/or sense the position of belt 302, preferably without direct physical contact or interaction with belt 302. As such, belt tracking actuators 306a, 306b may take various forms. For example, a pair of belt tracking actuators could take the form of a pair of photo-optic sensors that may visually detect or sense the position of a respective right side 302a and left side 302b of belt 302. If one of the photo-optic sensors detects that a certain side of belt 302 has shifted too far in one direction, or detects that belt 302 is oriented at an improper angle, a signal is sent to energize motor 350 to rotate motor shaft 352 in a certain direction depending on whether belt 300 is sensed as being too close to the right belt tracking actuator 306a or the left belt tracking actuator 306b. Alternatively, a pair of belt tracking actuators could take the form of a pair of laser sensors that project a beam or laser, such as an electromagnetic beam or laser, between a pair of arms, in which if belt 302 obstructs the laser, a signal is sent to energize motor 350 to rotate motor shaft 352 in a certain direction dependent upon which laser (the laser from the right belt tracking actuator or the laser from the left belt tracking actuator) was obstructed.

Another alternative embodiment could include only a single belt tracking actuator and/or sensor that could sense the position of a belt and send a signal to energize a motor to rotate a motor shaft in a certain direction depending on the alignment and/or orientation of the belt. For example, if a belt is sensed or detected as being too far to the left, or skewed to the left, the belt may be said to have leftwardly engaged the belt sensor. Alternatively, if the belt is sensed or detected as being too far to the right, or skewed to the right, the belt may be said to have rightwardly engaged the belt sensor. Based on whether the belt has leftwardly engaged the belt sensor or rightwardly engaged the belt sensor, a worm gear may be rotated rearward in a first direction or forward in a second direction to thus adjust an adjustable roller to correct the belt position and/or orientation.

It should be understood that the term “engaged” as used herein describes a scenario in which a belt may make physical contact with a belt tracking actuator, or in which a belt may be sensed or otherwise detected by a belt tracking actuator, such as belt tracking actuator in the form of a sensing device. It should also be appreciated that a conveyor surface adjustment system could include a single belt tracking actuator (as discussed above) or more than two belt tracking actuators. Additionally, it should be understood that various components of a conveyor surface adjustment system may vary from what has been described herein. For example, a roller adjuster could take other forms that vary from a worm gear, such as a circular component that is rotated by an external gear or driven and/or rotated by a motor. Furthermore, a first direction and/or a second direction may designate any direction(s), and as such may vary apart from what has been discussed herein.

Changes and modifications in the specifically described embodiments may be carried out without departing from the principles of the present invention, which is intended to be limited only by the scope of the appended claims, as interpreted according to the principles of patent law including the doctrine of equivalents.

1. A conveyor surface adjustment system comprising:
an adjustable roller configured to be in moveable contact with a conveyor belt of a conveyor system;
a roller adjuster configured to selectively adjust the position of said adjustable roller;
a belt tracking actuator; and
wherein said belt tracking actuator is configured to be actuated by the conveyor belt if the conveyor belt is in a misaligned condition with said belt tracking actuator in turn actuating said roller adjuster to adjust the position of said adjustable roller to adjust the tracking of the conveyor belt into an aligned condition.

2. The system of claim 1, wherein said belt tracking actuator comprises a rotational member that is configured to be engaged by the conveyor belt when the conveyor belt is in a misaligned condition with the conveyor belt imparting rotational motion to the belt tracking actuator, and wherein the belt tracking actuator in turn imparts rotational motion to the roller adjuster to adjust the position of the adjustable roller.

3. (canceled)

4. The system of claim 2, wherein the axis of rotation of said rotational member of said belt tracking actuator is configured to rotate either parallel to or perpendicular to the axis of rotation of said adjustable roller.

5. The system of claim 1, wherein said belt tracking actuator comprises a belt position sensor configured to detect a misalignment condition of the conveyor belt, and wherein said roller adjuster comprises an electric motor, and wherein said electric motor is configured to be actuated when said sensor detects a misalignment condition of the conveyor belt with said electric motor coupled to said adjustable roller for adjusting the position of said adjustable roller.

6. (canceled)

7. The system of claim 1, wherein said belt tracking actuator comprises a first belt tracking actuator and wherein said system further comprises a second belt tracking actuator, and wherein said first and second belt tracking actuators are to be disposed on opposed sides of the conveyor belt with said first belt tracking actuator configured to be actuated by the conveyor belt when in a first misaligned condition tracking to one side and with said second belt tracking actuator configured to be actuated by the conveyor belt when in a second misaligned condition tracking to the opposite side.

8. The system of claim 7, wherein said second belt tracking actuator comprises either a rotational member or a belt position sensor.

9. The system of claim 1, wherein said adjustable roller comprises a fixed end and a movable end, and wherein said roller adjuster is joined to said moveable end.

10. The system of claim 1, wherein said roller adjuster comprises a gear assembly and wherein an end of said adjustable roller is coupled to said gear assembly, and wherein rotation of said gear assembly adjusts the position of said adjustable roller.

11. The system of claim 10, wherein said gear assembly comprises a ring gear and wherein said end of said adjustable roller is coupled to said ring gear with an axis of rotation of said adjustable roller being offset from a rotational axis of said ring gear.

12. The system of claim 11, wherein said gear assembly comprises a spiral threaded shaft that engages with said ring gear, and wherein rotation of said spiral threaded shaft rotates said ring gear.

13. (canceled)

14. A conveyor belt adjustment system comprising:
an adjustable roller configured to be in moveable contact with a conveyor belt;
a roller adjuster configured to selectively adjust the position of said adjustable roller;
a first belt tracking actuator and a second belt tracking actuator disposed at opposing sides of the conveyor belt;
wherein said first belt tracking actuator is configured to be actuated by the conveyor belt when in a first misaligned condition tracking to one side, said first belt tracking actuator in turn actuating said roller adjuster in a first direction to adjust the tracking of the conveyor belt into an aligned condition; and
wherein said second belt tracking actuator is configured to be actuated by the conveyor belt when in a second misaligned condition tracking to the opposite side, said second belt tracking actuator in turn actuating said roller adjuster in a second direction to adjust the tracking of the conveyor belt into the aligned condition.

15. The conveyor belt adjustment system of claim 14, wherein said first belt tracking actuator is rotatable independent of said second belt tracking actuator when the conveyor belt actuates said first belt tracking actuator, and wherein said second belt tracking actuator is rotatable independent of said first belt tracking actuator when the conveyor belt actuates said second belt tracking actuator.

16. The conveyor belt adjustment system of claim 15, further comprising a fixed roller, wherein said first and second belt tracking actuators comprise horizontal pulleys disposed coaxially with and at opposite ends of said fixed roller.

17. The conveyor belt adjustment system of claim 14, wherein said adjustable roller comprises a fixed end located opposite a movable end, said movable end coupled to said roller adjuster such that a longitudinal axis of said adjustable roller is offset from a geometric center of said roller adjuster.

18. The conveyor belt adjustment system of claim 17, wherein said first and second belt tracking actuators are configured to rotate said roller adjuster when the conveyor belt actuates either of said first or second belt tracking actuators, the rotation of said roller adjuster moving said movable end along an arcuate path to pivot said adjustable roller.

19. The conveyor belt adjustment system of claim 18, wherein said movable end is movable between a position above said fixed end to cause the tension of the conveyor belt to be greater proximate said fixed end relative to the tension of the conveyor belt proximate said movable end, and a position below said fixed end to cause the tension of the conveyor belt to be greater proximate said movable end relative to the tension of the conveyor belt proximate said fixed end.

20. (canceled)

21. The conveyor belt adjustment system of claim 14, wherein said roller adjuster comprises a worm gear, further comprising a transmission shaft coupled to said first and second belt tracking actuators and to said worm gear, wherein said transmission shaft rotates in said first direction when the conveyor belt actuates said first belt tracking actuator, and wherein said transmission shaft rotates in said second direction when the conveyor belt actuates said second belt tracking actuator.

22. (canceled)

23. (canceled)

24. The conveyor belt adjustment system of claim 14, wherein said first and second belt tracking actuators comprise first and second vertical pulleys configured to rotate independently and oppositely relative to one another upon being actuated by the conveyor belt, further comprising a transmission band configured to transfer rotational motion from said first and second vertical pulleys to said roller adjuster.

25. The conveyor belt adjustment system of claim 14, further comprising an electric motor configured to rotate said roller adjuster, wherein said first and second belt tracking actuators comprise first and second sensors, wherein the conveyor belt actuates said sensors upon being detected by said first sensor to cause said electric motor to rotate said roller adjuster in said first direction, and wherein the conveyor belt actuates said second sensor upon being detected by said second sensor to cause said electric motor to rotate said roller adjuster in said second direction.

26. (canceled)

27-33. (canceled)

34. A conveyor belt adjustment system comprising:
a conveyor belt of a conveyor system;
a belt position sensor disposed proximate the conveyor belt;
an adjustable roller configured to be in moveable contact with the conveyor belt;
a roller adjuster configured to selectively adjust the position of said adjustable roller;
an electric motor in electronic communication with said belt position sensor and coupled to said roller adjuster;
wherein said electric motor is configured to urge said roller adjuster when the conveyor belt is detected by said belt position sensor, said conveyor belt detected by said belt position sensor when said belt is in a misaligned condition; and
wherein movement of said roller adjuster pivots said adjustable roller to adjust a tension of the conveyor belt at said adjustable roller to thereby adjust the tracking of the conveyor belt into an aligned condition.

35. The conveyor belt adjustment system of claim 34, wherein said belt position sensor is a first belt position sensor disposed proximate a first side of the conveyor belt, and further comprising a second belt position sensor disposed proximate a second side of the conveyor belt opposite the first side;
wherein said electric motor is configured to urge said roller adjuster in a first direction when said first belt position sensor detects the conveyor belt in a first misaligned condition tracking to one side;
wherein said electric motor is configured to urge said roller adjuster in a second direction opposite said first direction when said second belt position sensor detects the conveyor belt in a second misaligned condition tracking to an opposite side;
wherein movement of said roller adjuster in said first direction pivots said adjustable roller to adjust a tension of the conveyor belt at said adjustable roller to adjust the tracking of the conveyor belt into the aligned condition; and
wherein movement of said roller adjuster in said second direction pivots said adjustable roller to adjust a tension of the conveyor belt at said adjustable roller to adjust the tracking of the conveyor belt into the aligned condition.

36-40. (canceled)
